(19) United States
(12) Patent Application Publication
(10) Pub. No.: US 2005/0284396 A1
(43) Pub. Date: Dec. 29, 2005

(54) Bi-level aqua terrarium

(76) Inventor: Kent G. Bourbon, Sheridan, WY (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/144,873

(22) Filed: Jun. 3, 2005

Related U.S. Application Data
(60) Provisional application No. 60/576,880, filed on Jun. 3, 2004.

(51) Int. Cl. A01K 63/00

(52) U.S. Cl. 119/246

(57) ABSTRACT

A bi-level terrarium for a pet animal such as a crab comprising: a first level for placement proximate to the top of an aquarium tank and providing an orifice for the crab to enter and exit the aqua-terrarium; and a second level which is affixed to the first level for providing a dry area on which the crab can be situated.

### CROSS REFERENCE TO RELATED APPLICATIONS

This application claims benefit to provisional application 60/576,880, filed on Jun. 3, 2004, entitled “Bi-Level Aqua Terrarium”, which is incorporated herein by reference in its entirety.

### FIELD OF THE INVENTION

The present invention is directed to the field of terrariums and aquariums. In particular, the present invention is directed to a novel terrarium and aquarium or Aqua-Terrarium for small pet crabs such as fiddler crabs and red claw crabs. It would also be very suitable for many other animals such as hermit crabs and newts that prefer or require this type of environment.

### BACKGROUND OF THE INVENTION

Fiddler and red claw crabs are popular pets and are often kept with both tropical and non-tropical fish. One of the environmental conditions that must be maintained to raise these crabs successfully is an accessible terrestrial area and environment. If the crabs don't have access to a dry area they will attempt to climb out of the container any way they can (e.g. climbing the filters, hoses, etc.) where they frequently fall from the tank and die.

Presently, the recommended enclosure is an aquarium partially filled with water and a large amount of mud or gravel piled higher than the water level in some portion of the enclosure. This type of setup is acceptable for crabs but is far from ideal for raising tropical fish in the same aquarium and is not very aesthetic. Some of the more critical environmental concerns that need to be addressed with fish are salinity, temperature, water chemistry, turbidity, oxygen and predation. Although these conditions can be controlled by available aquarium equipment, this tank would be tedious to maintain, expensive and cluttered. There are a number of patents in the prior art directed to aquarium—terrarium systems. None have adequately addressed the problems of maintaining crabs and tropical fish in the same environment.

U.S. Pat. No. 5,970,918 is directed to an aquarium-terrarium ecosystem with both a containing area and a body of water is formed from a bottom section, a plurality of side plates, a concave shaped midsection, and a top section. The bottom section has at least three side edges. Each one of said plurality of side plates is attached to one of the side edges of the bottom section. Each one of the plurality of side edges extends substantially vertical from said bottom section. The longitudinal edges of each one of said plurality of side plates are connected to adjacent longitudinal side edges of adjacent side plates to form a polyhedron for containing a body of water. The polyhedron has a top edge. The concave midsection has both a forward and rear edge. The midsection is connected to at least a portion of the top edge of the polyhedron to form a separate containing area apart from the body of water. The forward edge of the midsection partially extends into the polyhedron to form an interface between the body of water and the separate containing area. The top section has a lower edge. The lower edge is connected to the rear edge of the midsection and the top edge of the polyhedron to enclose the aquarium-terrarium ecosystem.

U.S. Pat. No. 5,775,260 is discloses an enclosure which defines an extension located both immediately above and rearward of an aquarium with a front wall, a rear wall, opposing side walls, a bottom wall, an open top. The enclosure comprising a fame that includes a plurality of support members. Located about the frame members is a screen material or other material which defines the top, front, sides and rear walls of said enclosure. An opening is defined in the enclosure by the support members and the screen material. The opening is horizontally oriented, generally adjacent to the front wall and spaced below the top wall of the enclosure. The frame is adapted to be mounted relative to the aquarium such that the opening is generally coincidental with the open top of the aquarium. A portion of said enclosure is thus located above the aquarium with another portion of the enclosure located above and rearward of the rear wall of the aquarium. In this manner, the enclosure provides an enclosed space that extends both above and rearward of an aquarium so as to enable the healthy confinement of additional, principally land-based animals in a varied environment.

U.S. Pat. No. 5,690,054 discloses an aquarium system, consisting of a transparent-sided waterproof tank with flanges which support an undergravel filter with side inlet holes and a cleanout. The system also includes a base which supports the tank and encloses and screens a clean-out and drain system. The floor of the tank is translucent or transparent, and is shaped to provide one or more depressed areas into which aquarium wastes are directed by gravity and water flow, and from which the drain system allows the wastes and stale water to be removed without vacuuming.

U.S. Pat. No. 4,176,620 discloses an aquarium-terrarium tank. The edge surfaces of a terrarium floor are adhered to side walls of an aquarium tank. A terrarium compartment has a triangular cross section formed by the space above the terrarium floor and part of the side walls of the aquarium tank. The forward edge of the terrarium floor is spaced from the front or the side wall of the aquarium tank to form an opening therebetween of sufficient size for access to the body of water below the terrarium floor and movement of an amphibian between the body of water and the terrarium compartment. In a further embodiment, the terrarium compartment further includes a terrarium side wall adhered along the bottom edge to the terrarium floor to form an upwardly-extending barrier wall and thereby defines the terrarium compartment with a cross-sectional shape of a keystone.

U.S. Pat. No. 6,520,117 discloses a combination aquarium and terrarium comprising a standard ten-gallon aquarium tank containing water, a physically smaller terrarium and a containment lid. Standard ten-gallon aquarium tanks include a channel shaped band and a channel lip facing the interior of the tank. The terrarium is configured so that, when placed in the tank, the top edges of the terrarium will be positioned between the channel shaped band and the channel lip. A containment lid is provided that mounts on the top side of the channel lip, thereby depressing the terrarium. This downward pressure acts in conjunction with the buoyancy of the terrarium to fix the terrarium in place.

U.S. Pat. No. D473,347 discloses an ornamental design for a combined aquarium and terrarium. U.S. Pat. No. 5,337,701 discloses a habitat or castle for maintaining a minicrab within an underwater environment, such as within an aquarium, comprises a top shell which can encase an air bubble therein, and a platform which engages within the top shell to provide a perch for the minicrab within the air bubble. A base is provided which rests within, for example, gravel in the bottom of the aquarium, and a plurality of positionable legs are provided to elevate the habitat above the base plate at one of a plurality of pre-selected positions available.

U.S. Pat. No. 4,820,556 discloses a shelf system which provides a decorative ornament for use inside of aquariums or terrariums. A rigid planar sheet is provided with a means for removable attachment to the inside surface of the wall of an aquarium at any height along the wall. The attachment means does not alter the ability of the wall to hold water in the aquarium while maintaining a secure attachment to the inner surface of the aquarium wall. The shelf may be provided with ornamentation, particularly a decorative texture on the outer edge and it may be provided with a supporting column.

U.S. Pat. No. 4,788,938 is directed towards a floatable aquarium accessory formed to resemble a natural rocky shoreline setting. The invention provides a stable, landscapable, and functional terrestrial surface within the aquarium into which it is inserted. It moves vertically in response to changes in the water level of the aquarium while lateral movement in all directions is restricted by close contact with the interior side walls of the aquarium. The invention conceals the aquarium's water filtration system within removable enclosing members which also resemble natural rock formations. Additionally, it supports the system at the proper position in relation to the water level of the aquarium for its normal operation. The upper terrestrial surface contains a number of depressions for holding aquarium gravel and terrestrial plants. The outflow of water from the water filtration system may be diverted over its enclosing formation. This creates a simulated waterfall which serves as a point of interest for the terrestrial setting while enhancing the aquatic scene below.

U.S. Pat. No. 6,029,605 discloses a tank which provides multiple environments in upper and lower regions of the tank. A land plate divides the tank into the upper and lower regions and provides a terrestrial environment in which terrestrial and amphibious animals can live. A ramp extends from the land plate into the lower region, which is filled with water to a minimum water level of at least the bottom edge of the ramp. When filled with water to the minimum water level, the lower region provides an aquatic environment in which aquatic and amphibious animals can live. The ramp allows travel between the terrestrial environment and the aquatic environment. An opening in an end of the tank beneath the land plate allows for easy access to and maintenance of the aquatic environment. An island can also be placed beneath the land plate, and opaque material can be placed on the walls of the tank in the lower region to provide a subterranean environment.

None of these aquarium systems meet the needs of both fish and crabs such as fiddler and red claw crabs. It would be desirable to provide a system which would enable crustacea such as crabs to be raised with tropical and non-tropical fish.

It is an object of the present invention to provide a novel aqua-terrarium for crustaceans such as fiddler and red leg crabs to live that works in conjunction with an aquarium without altering its normal operating environment.

It is a further object of the present invention to provide a bi-level terrarium system which meets the needs of both fish and crustaceans such as fiddler and red leg crabs.

It is still a further object of the invention to provide a terrarium which is configured to be placed on a convection aquarium.

These and other objects of the present invention will become apparent from the detailed description which follows.

### SUMMARY OF THE INVENTION

In accordance with the invention, a bi-level aqua-terrarium for a pet animal such as a crab comprising of: A first level for placement, arranged on the top of an aquarium tank in front of the light hood, providing an orifice for the crab to enter and exit the aqua-terrarium. A second level for placement, arranged on top of the aquarium light hood and affixed to the back of the first level, providing an area in which the crab can move and thrive. The system may also include a water hole to permit water to be pumped into the aqua-terrarium and flushed through the system. Air vents are also provided in the first and second level.

In a further embodiment, the invention is a bi-level aqua-terrarium for a pet animal such as a crab comprising: a first level for placement proximate to the top of an aquarium tank and providing an orifice for the crab to enter and exit the terrarium; a second level which is affixed to the first level for providing a second area on which the crab can be situated; and an orifice for the flow of water between the first and second levels; a water orifice in the second level to permit water to be pumped into the aqua-terrarium and flushed through the system.

### BRIEF DESCRIPTION OF THE FIGURES

FIG. 1 is an elevational view of the terrarium of the present invention.

FIG. 2 is a side perspective view of the terrarium of the present invention.

FIG. 3 is a top perspective view of the terrarium of the present invention showing the access hole to the aquarium.

FIG. 4 is a front view of the present invention.

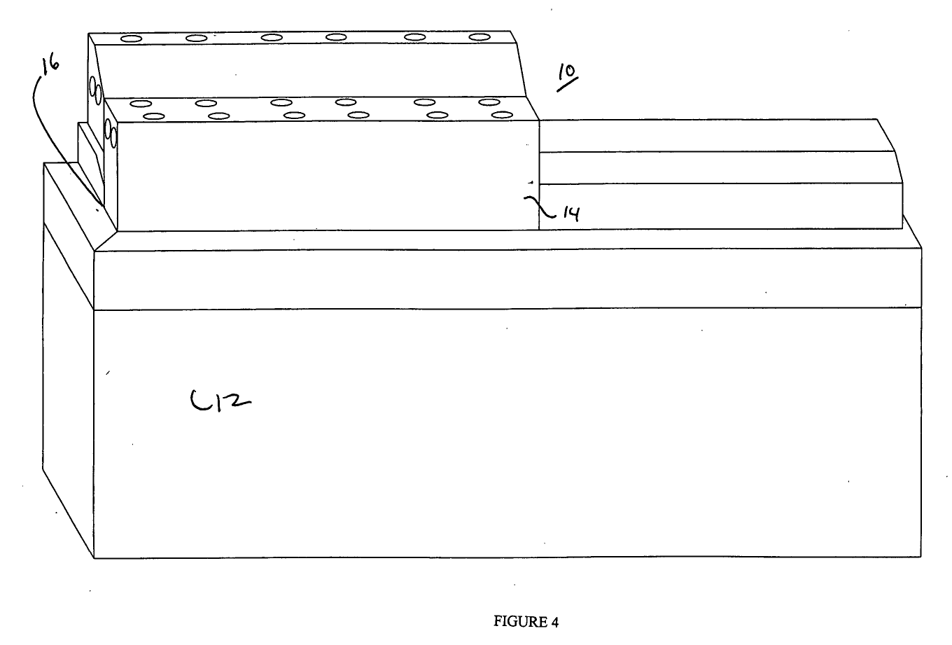

FIG. 5 is a side view of the present invention.

### DETAILED DESCRIPTION OF THE PRESENT INVENTION

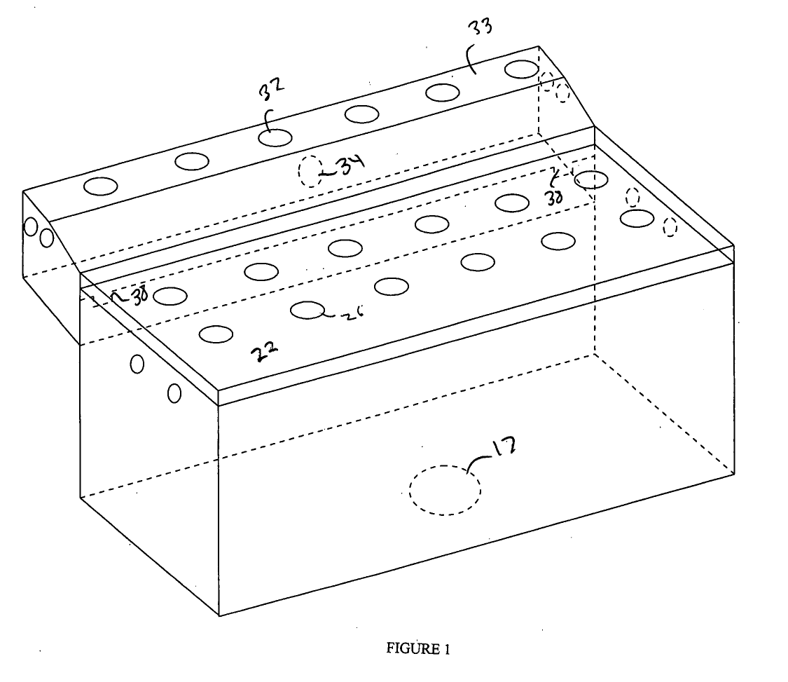

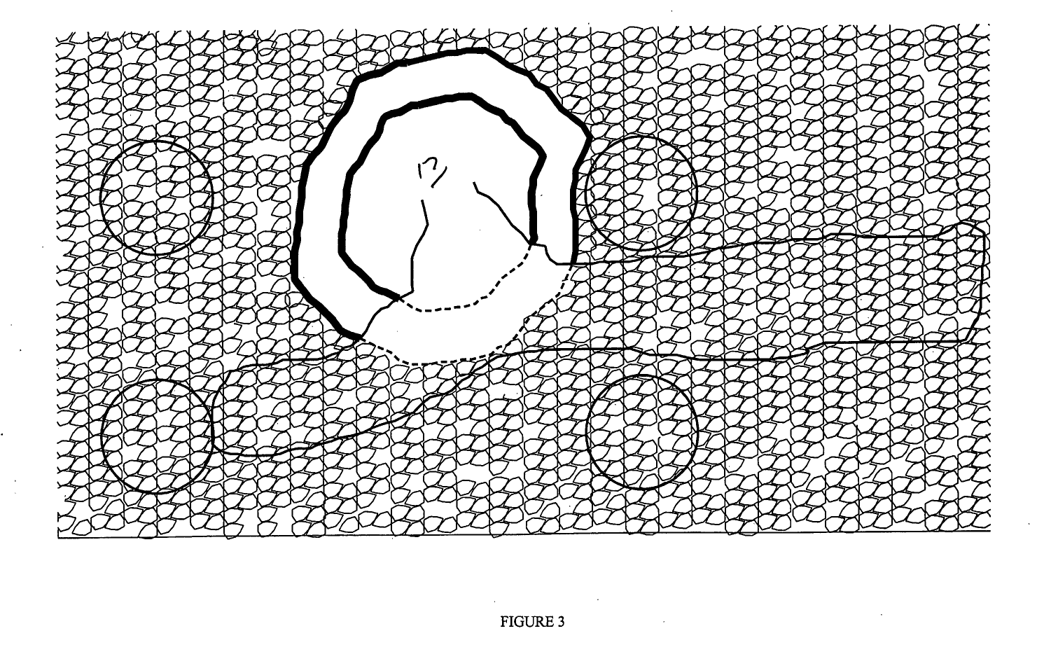

The present invention is described with reference to the enclosed figures wherein the same numbers are used. Referring to FIGS. 1 and 3, the present invention is directed to a novel crustacean aqua-terrarium that can be used with and in association with a tropical fish aquarium. The most preferred embodiment is designed to be used with crustaceans such as fiddler or red claw crabs. The present invention, in a most preferred embodiment comprises a bi-level plastic structure 10. In a preferred embodiment, the terrarium is preferably constructed from one of a variety of polymers and plastics such as Lexan.

The terrarium is mounted on top of the aquarium 12. The lower level of this device 14 is placed in front of the lamp hood 16 in place of the cover of the aquarium. As shown in FIG. 3, the lower level 14 has a two-inch hole 17 in the bottom center which permits the crab to enter and exit the aqua-terrarium via the aquarium and to permit water to flow out. The back 18 of the enclosure rises up to below the top cover forming a weir with two small overflow channels located near each side. It also has two vent holes on each side 20 near the top of the edge. A lid 22 completely covers the length of the lower level 14 with a plurality of vent holes 26.

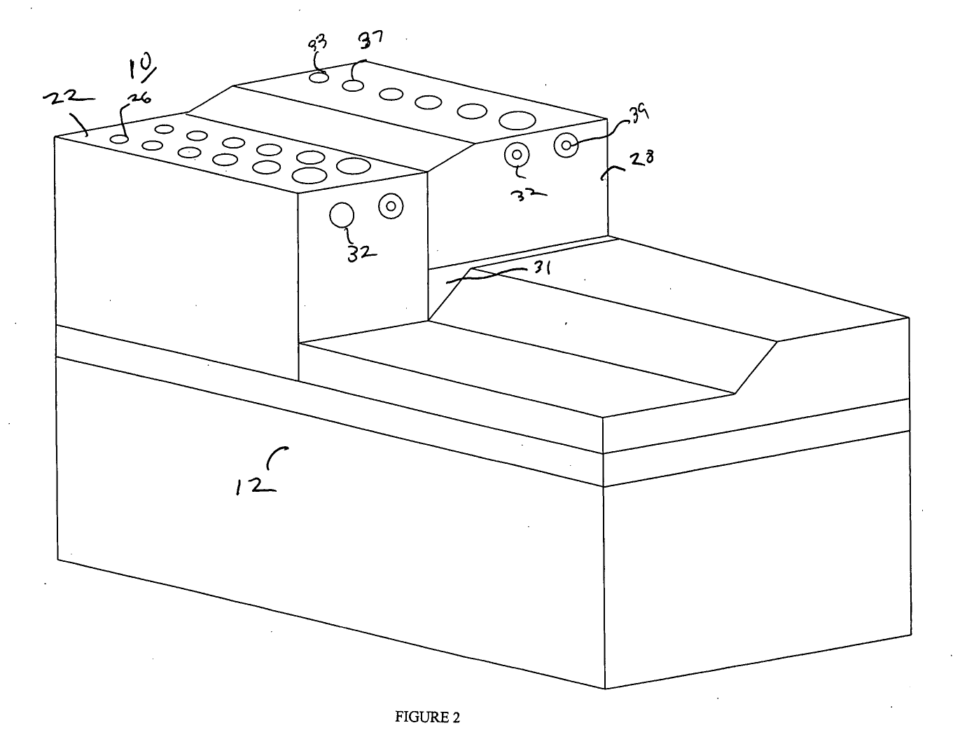

Referring to FIG. 2, the upper level portion 28 of the enclosure is designed to set on top of the lamp hood 16 of the aquarium. The upper level portion 28 has a front section 31 which angles down to the back of the lower level, stopping at the top of the lower level ends and back of cover. The upper level similarly has a lid 33 with vent hole 37. Each end has two vent holes 32 near the top edge. These vents are approximately one half inch in diameter and can be reduced with plugs 39 to compensate for small animals such as newts.

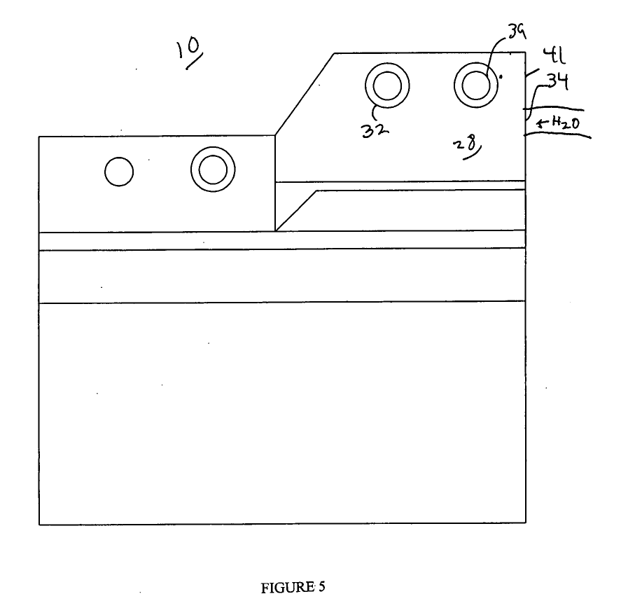

Referring to FIGS. 1 and 5, the back wall 1 of the upper portion 28 has a water supply hole 34 at the top center below the top edge of cover 33. Preferably, cover 33 completely covers the length of the upper level with eight evenly distributed vent holes 37. The water flows through the supply hole and through the two overflow channels 38 between the upper and lower section and into the aquarium through the central orifice. The water permits the system to be flushed and remain clean.

The aqua-terrarium is preferably filled with sand/gravel (benthic substrate), rocks (substrate and security cover), drift wood (security cover) and artificial plants (security cover) so as to provide a comfortable and appealing environment for the crabs. As can be seen, the bottom portion of the aqua-terrarium seats to the top of the aquarium forming a shallow weir.

The invention thus provides a system, which permits crabs such as fiddler and red claw crabs to have a terrestrial area in association with an aquarium, without interfering with the fish. The crab can then climb out of the aquarium up into the lower level or up to the upper level and have an independent water source and be easily viewed in their natural terrestrial habitat.

In other embodiments, the invention includes vent hole reduction plugs. The aqua-terrarium could also come with an adapter 40 to fit a plurality of aquariums.

The present invention has been described with reference to the enclosed preferred embodiment. It is to be appreciated that the true nature and scope of the invention is to be determined with reference to the attached claims.

1. A bi-level aqua-terrarium for a pet animal such as a crab comprising:
a first level for placement arranged on the top of an aquarium tank having a light and providing a habitat with an orifice for the crab to enter and exit the aqua-terrarium; and
a second level for placement on the light hood for providing an additional area, in which the crab can move and live.

2. The aqua-terrarium of claim 1 wherein the second level rests on the light hood of the aquarium.

3. The terrarium of claim 1 wherein the first level has an orifice for permitting a crab to enter and exit the aquarium.

4. The terrarium of claim 1 further comprising a water hole to permit water to be pumped into the aqua-terrarium and flushed through both levels.

5. The bi-level aqua-terrarium of claim 1 further comprising air vents attached to the first and second levels.

6. A bi-level aqua-terrarium for a pet animal such as a crab comprising:
a first level for placement proximate to the top of an aquarium tank and providing an orifice for the crab to enter and exit the terrarium;
a second level which is affixed to the first level for providing a second area on which the crab can enter and move;
at least one overflow channel for facilitating the flow of water between the first and second levels; and
a water hole in the second level to the permit water to be pumped into the aqua-terrarium and flushed through the system.
